(19) United States
(12) Patent Application Publication
(10) Pub. No.: US 2020/0027571 A1
(43) Pub. Date: Jan. 23, 2020

(54) Thermal Wave Drive for ICF Targets

(71) Applicants: Eric W. Cornell, Colorado Springs, CO (US); Robert O. Hunter, JR., Aspen, CO (US); David H. Sowle, Santa Maria, CA (US); Adlai H. Smith, Escondido, CA (US)

(72) Inventors: Eric W. Cornell, Colorado Springs, CO (US); Robert O. Hunter, JR., Aspen, CO (US); David H. Sowle, Santa Maria, CA (US); Adlai H. Smith, Escondido, CA (US)

(73) Assignee: INNOVEN ENERGY LLC, Colorado Springs, CO (US)

(21) Appl. No.: 16/191,669

(22) Filed: Nov. 15, 2018

Related U.S. Application Data
(60) Provisional application No. 62/587,169, filed on Nov. 16, 2017.

(51) Int. Cl. G21B 1/03; G21B 1/19; G21B 1/15

(52) U.S. Cl. CPC G21B 1/03; G21B 1/15; G21B 1/19

(57) ABSTRACT

A system and method for driving an ICF target with a thermal wave comprising: a target assembly, located inside a hohlraum, comprising a drive region, shell region and central fuel region; wherein said hohlraum comprises one or more laser entrance apertures; wherein said one or more laser entrance apertures are sized according to the shape of said hohlraum and to prevent energy from escaping said hohlraum; a laser assembly to irradiate a laser pulse through said laser entrance apertures; inner walls of said hohlraum to reradiate said laser pulse as x-ray radiation; wherein said x-ray radiation penetrates the target assembly as a thermal wave before any significant hydrodynamic motion occurs within said target assembly during the time in which the laser assembly is active; wherein said drive region is evenly heated to a sufficient temperature to expand in an inward and outward direction; and wherein said shell region is launched into said fuel region to drive said ICF target.

### CROSS-REFERENCE TO RELATED APPLICATIONS

This application claims the benefit of U.S. Provisional Application No. 62/587,169 filed on Nov. 16, 2017, which is incorporated herein by reference.

### BACKGROUND

Inertial Confinement Fusion (“ICF”) is a process by which energy is produced by nuclear fusion reactions. The fuel pellet, generally called the target, is conventionally a spherical device which contains fuel for the fusion process. Various ways of driving and imploding the target have been utilized and considered (lasers, ion beams, etc.). These drives transfer energy to the target which then implodes and ignites the fuel. If the fuel is sufficiently heated and compressed, a self-sustaining fusion reaction occurs, wherein the fuel self-heats and produces energy from the fusion reaction.

If the target is to be useful for energy production, it must output more energy than the amount of energy needed to drive the implosion. The amount of energy needed to drive the target may be quite high, as very high temperatures and densities are required to initiate fusion reactions. Also, the amount of energy needed to drive the target must be physically and economically achievable.

The conventional approach to ICF target design is exemplified by the Department of Energy's program, NIF (National Ignition Facility). NIF target designs, as described in Lindl, “The Physics Basis for Ignition Using Indirect Drive Targets on the National Ignition Facility”, consists of a mostly plastic or beryllium ablator region which surrounds a cryogenic DT ice, and a central void which is filled with very low density DT gas. The target is then placed in a cylindrical hohlraum. The entire target assembly (hohlraum and target) are then placed in the target chamber, where a 192 beamline laser delivers up to 1.8 MJ of energy to the hohlraum. The hohlraum converts the energy to x-rays which then ablate the ablator region, and by the reactive force drives the DT shell inward. This ablation process may take a very long time in comparison to the hydrodynamic motion of the target material. Due to this long time-scale, NIF hohlraums must have very large laser entrance holes. As the temperature of the hohlraum rises, the hohlraum material will be ablated and thereby begin to close these holes. If the holes close or become too small, the laser light will not be able to enter the hohlraum. One effect of having these large holes is that radiation is then allowed to escape the hohlraum and that energy then becomes unusable by target. Another effect of a long laser pulse is that although the hohlraum walls are fairly reflective to radiation, a significant portion of the laser energy is lost to the heating of the hohlraum walls. This means NIF targets are unable to efficiently use the energy from the laser.

Since the time scale of the laser pulse length must be long for this ablation process, the target and/or hohlraum may move during the laser pulse. If this happens there may be increased non-uniformity of the energy deposition on the target's surface. This increased non-uniformity may lead to increased Raleigh-Taylor instability growth at the shell/fuel interface and ignition failure.

NIF targets have, up to now, never ignited. The areal density (pr) of the fuel and the temperature of the fuel has, to date, fallen short of the 0.3 g/cm² and 10 keV they believe they require. It is not clear why the NIF targets have not achieved ignition, but it may be due to lower than expected shell velocities and greater than expected Raleigh-Taylor instability growth.

Unless otherwise indicated herein, the materials described in this section are not prior art to the claims in this application and are not admitted to be prior art by inclusion in this section.

### SUMMARY

ICF targets and their designs are discussed in which less energy is lost to heating the hohlraum, as well as less energy escaping the laser entrance holes by reducing the size of these holes. This necessarily reduces the laser pulse length in time and changes the requirements for how those targets are driven. These targets may then also benefit from improved stability and symmetry requirements.

In accordance with the present invention, a system and method for driving an ICF target with a thermal wave is described. The ICF target is located within a hohlraum which comprises one or more laser entrance apertures sized accordingly. A laser assembly irradiates a laser pulse through the laser entrance apertures to reradiate as x-ray radiation within the inner walls of the hohlraum to penetrate the ICF target as a thermal wave. A drive region is then evenly heated to a sufficient temperature to expand in an inward and outward direction wherein a shell region is launched into a fuel region to drive the ICF target.

### DRAWINGS

FIG. 1 shows (a) a thermal wave and (b) an ablative heating wave.

FIG. 2 shows one embodiment in which a drive region surrounds a high Z shell, which then surrounds a fuel region.

FIG. 3 shows a target assembly (spherical target and cylindrical hohlraum).

FIG. 4 shows one example of a cylindrical hohlraum having laser entrance apertures on both ends.

### TERMINOLOGY AND REFERENCE NUMERALS

| | |
|---|---|
| 102 | Ambient Material (AM), areal density = ρ_{A} |
| 104 | Shocked Material (SM), areal density > ρ_{A} |
| 106 | Rarefacted Material (RM), areal density < ρ_{A} |
| 108 | Vacuum (V) or Ambient Atmosphere Outside of Shell |
| | Material |
| 110 | Temperature (T) |
| 112 | Thermal Wave Material Temperature Profile (Tₚ) |
| 114 | Ablative Wave Material Temperature Profile (Tₚ′) |
| 116 | External or Incoming Radiation (qₑₓ) |
| 118 | Propagation Front (F) of the Thermal Wave |
| 200 | Target |
| 202 | Central Fuel Region |
| 204 | Shell Region |
| 206 | Drive Region |
| 300 | Hohlraum |
| 302 | Entrance Aperture of Hohlraum |
| 304 | Hohlraum Walls |
| 400 | Target Assembly |

### DETAILED DESCRIPTION

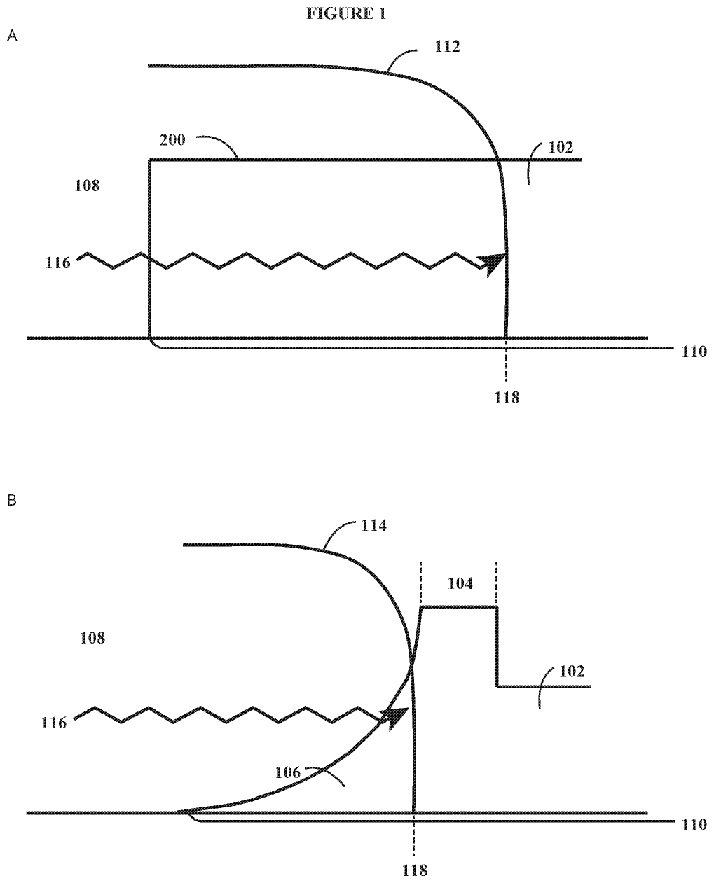

A supersonic radiative thermal wave (thermal wave) is a direct heat transfer by radiation (x-ray or laser photons) and has the characteristic of propagating through the medium at a speed greater than the speed of sound. For incident radiation of temperature (T) 110, radiative thermal conductivity is a strong and rapidly increasing function of T (˜T⁴⁵⁻⁵⁵) resulting in a temperature profile 112 (FIG. 1a) deposited in the material which is practically constant from the vacuum or ambient atmosphere region 108 up to the point 118 where it rapidly falls off. Temperature profile 112 and associated front 118 characterizes the intensity and extent of the thermal wave (FIG. 1a). A principal characteristic of thermal waves is the propagation of front 118 at speeds greater than the local sound speed in a medium resulting in a density profile (φ substantially unchanged from the material's ambient density (ρ_{A}). Depending on the context, areal density is defined as follows:

Areal Density=∫₀^{r}dr′ρ(r′) or ∫ᵣ₁₀₄^{r}dr′ρ(r′)

At lower intensities/shorter pulse lengths for qₑₓ, a subsonic ablative heating wave 114 (FIG. 1b) is generated. Temperature profile 114 is qualitatively similar to 112 but the propagation speed of front 118 is subsonic resulting in a significant material rarefaction wave 106, and a region of higher (than ambient AM) density shocked material 104 ahead of front 118. So if the external radiation 116 temperature is high enough and/or of short duration, a thermal wave will penetrate the drive region without ablating the surface or generating a shock wave during the interval qₑₓ is on or externally irradiates material. Application of this thermal wave as opposed to the ablative wave of FIG. 1b is the subject of this application. This is in contrast to conventional ICF applications utilizing an ablative wave mechanism as depicted in FIG. 1b.

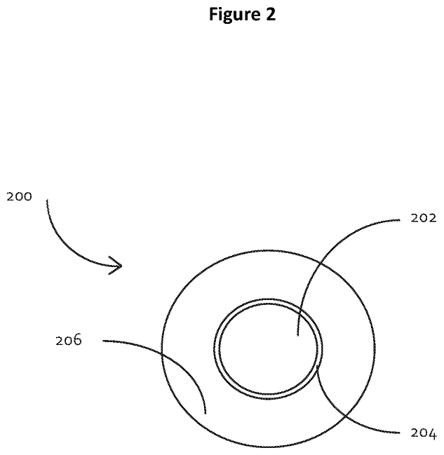

As shown in FIG. 2, spherical target 200 comprises a central fuel region 202, shell region 204 and drive region 206. In a first embodiment of this invention, fuel region 202 may be filled with equimolar deuterium-tritium (DT) at a density of 0.15 g/cc. Fuel region 202 may have an outer radius of 0.078 cm. Fuel region 202 may then be surrounded by shell region 204. Shell region 204 may be solid tungsten metal with an outer radius of 0.083 cm. Surrounding shell region 204 may be a drive/ablator region 206. Drive region 206 may be made of boron nitride at a density of 3.45 g/cc. Drive region 206 may have an outer radius of 0.197 cm.

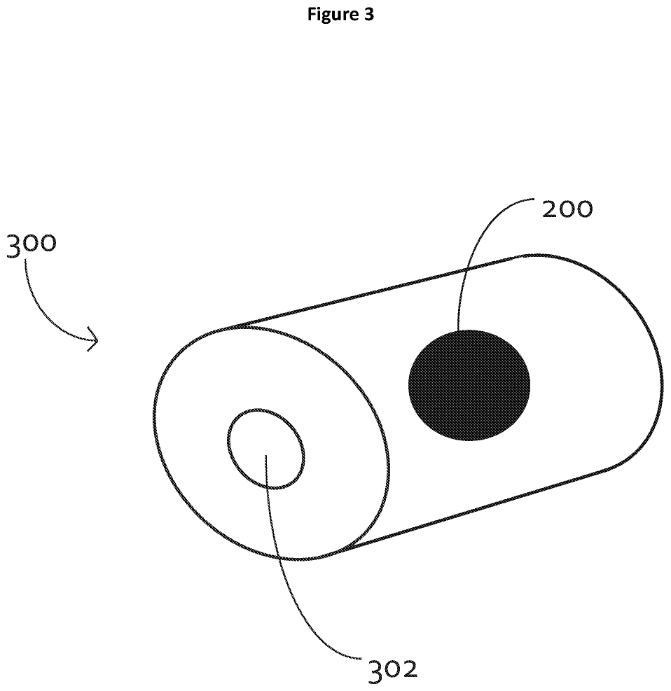

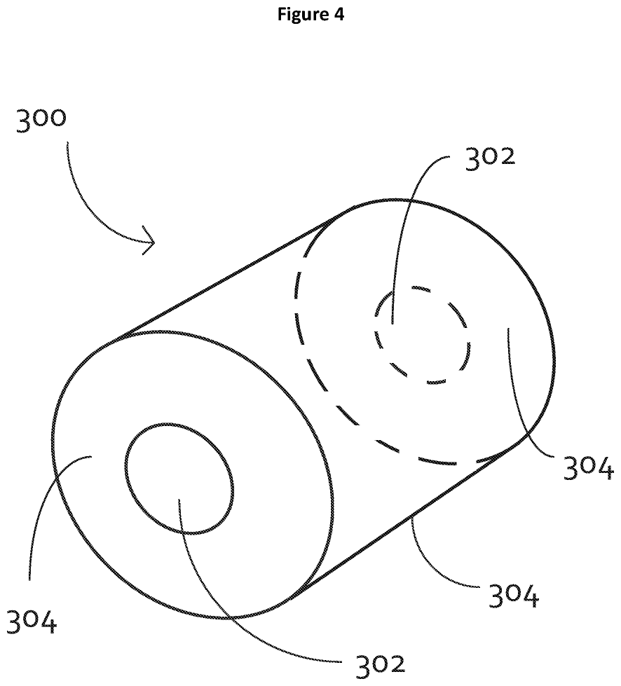

As shown in FIG. 3, target assembly 400 includes both the target 200 and hohlraum 300. Target 200 may be placed in any one of a variety of shaped hohlraums 300 including but not limited to spherical, cylindrical, or rugby shaped (cylindrical shaped is depicted in FIG. 3) having one or more laser entrance apertures 302 appropriate to the shape of hohlraum 300. As shown in FIG. 4, hohlraum 300 may be gold, tungsten, or any high-Z material that is reflective to radiation. The laser light will then enter hohlraum 300 through said aperture(s) 302 and illuminate hohlraum 300. Hohlraum walls 304 will then reradiate the laser energy as x-ray radiation and the radiation field will fill hohlraum 300. Referring back to FIG. 2, if the radiation temperature is high enough it will, instead of ablating the exterior of drive region 206 drive a thermal wave into the material which will penetrate the material and ionize it before any significant hydrodynamic motion occurs in that region. As this thermal wave does not ablate the surface of drive region 206, there is no shock driven into the material, and therefore no change in the density of the material. The entirety of drive region 206 may then be evenly heated to the temperature of said thermal wave. Drive region 206 may then begin to expand in both the outward and inward directions. As drive region 206 expands, shell region 204 will begin to move inwardly. The sudden inward motion of shell 204 will launch a shock into fuel region 202. This shock will carry some amount of energy with it and begin to heat fuel region 202. During the time said shock is travelling toward the origin of the sphere, shell region 204 will compress fuel region 202 as shell region 204 moves inwardly. If fuel region 202 is sufficiently compressed and heated, fuel region 202 may ignite due to fusion reactions and enter run-away burn where the fusion reactions in fuel region 202 sustain the burning of the fusion fuel.

Some amount of the laser energy entering hohlraum 300 will heat hohlraum wall 304. This energy never reaches the target and may be thought of as a loss. This loss is highly dependent on the time in which the laser is active. One advantage of this process is the pulse length requirement for the laser. Since the initial heating of ablator region (206, FIG. 2) may occur on a very short time scale (˜1 nanosecond), the laser pulse may also be very short (˜1 nanosecond), thus significantly reducing the energy lost to hohlraum wall (304, FIG. 4).

Another loss of energy occurs as radiation leaves the hohlraum through holes 302. The larger the holes are, the more energy that is lost through them. The required size of holes 302 is dependent on the length of the laser pulse. Since the wall surrounding hole 302 will be ablated by the radiation field and shrink and possibly close, hole 302 must be large enough to remain open during the time when the laser is active.

Another advantage of this invention is that no significant hydrodynamic motion occurs within target assembly 400 during the time in which the laser is active. However, in conventional ICF targets, a long ablation process where the laser is active for tens of nanoseconds, the target may shift or move in relation to hohlraum 300 and thus create asymmetries in the energy deposited on the surface of the target. These asymmetries may then lead to an asymmetrical implosion, and if the asymmetries are great enough the target may not ignite.

In conventional targets which are driven by ablation, the ablation process is used to tailor the pressure profile on the outside of shell 204. In targets driven by a thermal wave penetrating drive region 206, it may be preferred to tailor the pressure profile on the outside shell 204 by structuring drive region 206 in different fashions. One can imagine many variations. Ablator region 206 could, instead of being a homogenous region, be layered with different materials or the same material at different densities. For instance, if the density of drive region 206 smoothly transitioned from the greatest density on the outside to the least dense on the inside, a longer pressure pulse on the outside of shell 204 would be created as the inner material would push earlier in time and the material further out would follow. The material in ablator region 206 could be chosen for its opacity, or lack thereof, to radiation of a certain spectrum or temperature.

In some embodiments fuel region 202 may have a higher ratio of deuterium to tritium, or conversely, a higher ratio of tritium to deuterium. Fuel region 202 could be filled with other types of fusion fuel, such as: pure deuterium fuel, lithium deuteride, lithium deuteride with lithium tritide, equimolar deuterium and tritium (DT) or DT with a reduced or increased fraction of tritium, or proton-Boron 11 (p¹¹B).

Other materials could be substituted for tungsten in shell 204. For instance, copper could be used. The requirement for the material in shell 204 is that it must contain the radiation in fuel region 202 up until ignition. High-Z materials may be preferred to accomplish this as they will be more reflective to said radiation.

Embodiments of this invention discussed in this application were designed using numerical simulations and hand calculations. This design process necessarily involves making approximations and assumptions. The description of the operation and characteristics of the embodiments presented above is intended to be prophetic, and to aid the reader in understanding the various considerations involved in designing embodiments, and is not to be interpreted as an exact description of how embodiments will perform, an exact description of how various modifications will change the characteristics of an embodiment, nor as the results of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. A system for driving an ICF target with a thermal wave comprising:
a target, located inside a hohlraum, comprising a drive region, shell region and central fuel region;
one or more laser entrance apertures within said hohlraum wherein said one or more laser entrance apertures are sized to correspond to the shape of said hohlraum and to prevent energy from escaping said hohlraum;
a laser assembly to irradiate a laser pulse through said laser entrance apertures;
a plurality of inner walls to define the shape of the hohlraum, wherein said inner walls reradiate said laser pulse as x-ray radiation and wherein said x-ray radiation penetrates the target as a thermal wave before any significant hydrodynamic motion occurs within said target during the time in which the laser assembly is active;
said drive region evenly heats to a sufficient temperature to expand in an inward and outward direction; and
said shell region launches into said fuel region to drive said ICF target.

2. The system of claim 1, wherein said drive region further comprises a plurality of distinct materials arranged in a layered fashion.

3. The system of claim 1, wherein said drive region further comprises a plurality of similar materials having different densities arranged in a layered fashion.

4. The system of claim 3, wherein said drive region is arranged as a smooth transition from a higher density material on the outside to a less dense material on the inside.

5. The system of claim 1, wherein said hohlraum is selected from one of the following shapes: spherical, cylindrical or rugby shaped.

6. The system of claim 1, wherein said drive region is heated in a short time scale of approximately 1 nanosecond and said laser pulse is irradiated in a short duration of approximately 1 nanosecond.

7. A method for driving an ICF target with a thermal wave comprising:
irradiating a laser pulse through one or more laser entrance apertures of a hohlraum toward a target, wherein said target comprises a drive region, shell region and central fuel region;
sizing said one or more laser entrance apertures according to the shape of said hohlraum and to prevent energy from escaping said hohlraum;
reradiating said laser pulse as x-ray radiation upon interaction with the inner walls of said hohlraum;
penetrating the target with the x-ray radiation as a thermal wave before any significant hydrodynamic motion occurs within said target during the time in which the laser assembly is active;
evenly heating said drive region to a sufficient temperature to expand in an inward and outward direction; and
launching said shell region into said fuel region to drive said ICF target.

8. The method of claim 7, further comprising:
irradiating said drive region having a plurality of distinct materials arranged in a layered fashion.

9. The method of claim 7, further comprising:
irradiating said drive region having a plurality of similar materials of different densities arranged in a layered fashion.

10. The method of claim 9, further comprising:
irradiating said drive region from a higher density material on the outside through to a less dense material on the inside.

11. The method of claim 7, further comprising;
irradiating a spherical, cylindrical or rugby shaped hohlraum.

12. The method of claim 7, further comprising:
heating said drive region in a short time scale of approximately 1 nanosecond; and
irradiating said laser pulse in a short duration of approximately 1 nanosecond.
